(19) United States
(12) Patent Application Publication
(10) Pub. No.: US 2022/0378031 A1
(43) Pub. Date: Dec. 1, 2022

(54) Fishing Rod Holder

(71) Applicant: John William Hayes, Palm Coast, FL (US)

(72) Inventor: John William Hayes, Palm Coast, FL (US)

(21) Appl. No.: 17/830,209

(22) Filed: Jun. 1, 2022

Related U.S. Application Data
(60) Provisional application No. 63/195,344, filed on Jun. 1, 2021.

(51) Int. Cl. A01K 97/10; B63B 34/26

(52) U.S. Cl. CPC A01K 97/10; B63B 34/26

(57) ABSTRACT

A fishing rod holder includes an arch body, a support lip, a handle opening, and an alignment slot. The arch body that functions as the rigid holding structure includes a flat base, a left arch wall, and a right arch wall. The left arch wall and the right arch wall are oppositely positioned of each other about the flat base. The left arch wall is perpendicularly connected to the flat base. The right arch wall is perpendicularly connected to the flat base. The support lip is connected to a front end of the flat base and provides a platform to secure the pole section of the fishing rod. The handle opening traverses through a rear end of the flat base thus allowing to insert the handle section of the fishing rod. The alignment slot centrally traverses through the flat base and allows the arch body to be mounted to kayaks.

The current application claims a priority to the U.S. Provisional Patent application Ser. No. 63/195,344 filed on Jun. 1, 2021.

### FIELD OF THE INVENTION

The present invention relates generally to an apparatus for a rod holder. More specifically, the present invention is an apparatus for a rod holder that can attach to kayaks, boats of all types, docks, and etc. to hold fishing rods and reels.

### BACKGROUND OF THE INVENTION

Kayak fishing is generally identified as fishing from a kayak. The kayak has long been a means of transportation and a means of accessing fishing grounds in saltwater and freshwater which has gained popularity in recent times. Some of the biggest benefits of kayak fishing are in the ease of use and transportation, the affordability of the equipment compared to motorized boats, eco-friendly watercraft usage, and physical exercise that the user gain through the fishing process. Many of the techniques used in kayak fishing are essentially the same as those used on other fishing boats. The difference is in the set-up fishing gear, how each piece of fishing equipment is fitted to the kayak, and how each activity is carried out on such a small craft. In order to secure the fishing rod to the kayak, it is essential to secure a fishing rod holder to the kayak. Existing rod holders are designed for boats of all sizes, but none specifically for kayaks. Because of their larger size, these existing rod holders must be modified to fit the rail systems of the smaller kayak. Furthermore, because of how the larger rod holders operate, the rods and reels may become damaged or lost due to the awkward size.

It is an objective of the present invention to provide a rod holder that can specially be mounted to a kayak and but also mounted to boats of all types, docks, and etc. The present invention can be securely mounted to the kayak to lock the fishing rod within. Furthermore, components of present invention and their configuration are able to provide a rigid base structure to the fishing rod during usage. The present invention also enables the user to adjust the angle of the fishing rod during usage. This invention is designed specifically for kayaks but can be adapted to larger boats. As a result, the present invention provides an improve rod holder over the existing fishing rod holders.

### BRIEF DESCRIPTION OF THE DRAWINGS

FIG. 1 is a left perspective view of the present invention.

FIG. 2 is a right perspective view of the present invention.

FIG. 3 is a right side view of the present invention showing the flange section and the reel locking section of the right arch wall.

FIG. 4 is a left side view of the present invention showing the flange section and the reel locking section of the right arch wall.

FIG. 5 is a top view of the present invention.

### DETAIL DESCRIPTIONS OF THE INVENTION

All illustrations of the drawings are for the purpose of describing selected versions of the present invention and are not intended to limit the scope of the present invention.

The present invention is a fishing rod holder that attaches to kayaks, boats of all types, docks, and etc. The present invention securely holds a fishing rod and reel and allows the user to engage in other activities such as paddling. The present invention is preferably manufactured using the injection molded process, which is well known for its ability to maintain all of the design characteristics. The present invention preferably uses high-density plastic that is impervious to all chemicals and is extremely strong and very durable.

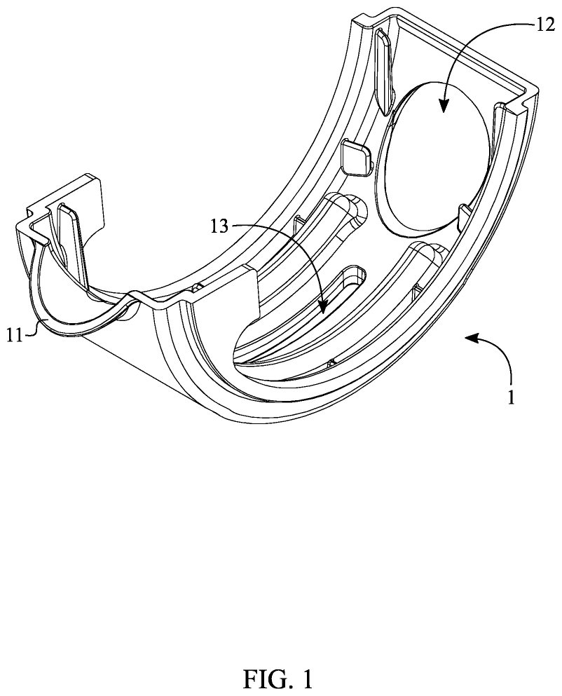

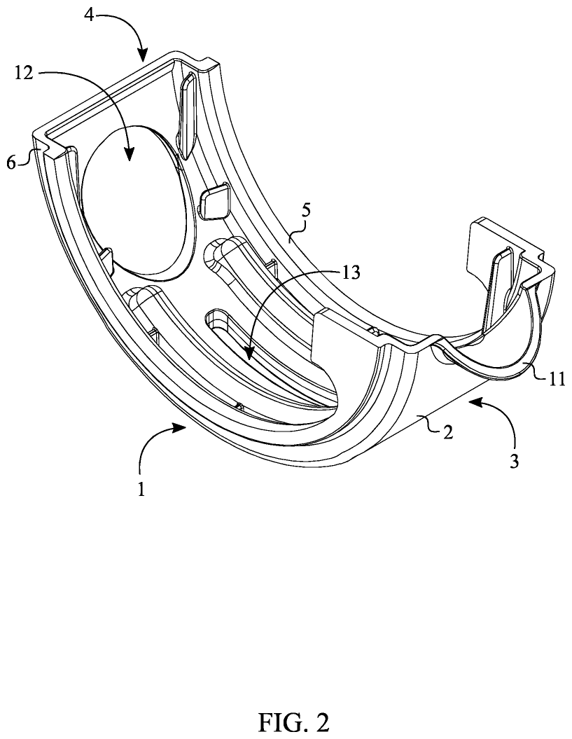

As shown in FIG. 1-2, the present invention comprises an arch body 1, a support lip 11, a handle opening 12, and an alignment slot 13. The arch body 1 is a semicircular body and functions as the main structural component comprises a flat base 2, a left arch wall 5, and a right arch wall 6. In reference to the general configurations, the left arch wall 5 and the right arch wall 6 are oppositely positioned of each other about the flat base 2 so that the arch body 1 can maintain the semicircular shape through the usage of the present invention. More specifically, the left arch wall 5 is perpendicularly connected to the flat base 2, and the right arch wall 6 is perpendicularly connected to the flat base 2. The support lip 11 is connected to a front end 3 of the flat base 2 and centrally aligned within the left arch wall 5 and the right arch wall 6. The support lip 11 provide a channeled platform within the flat base 2 so that the pole section of the fishing rod can be placed through the flat base 2. The handle opening 12 traverses through a rear end 4 of the flat base 2 and centrally aligned within the left arch wall 5 and the right arch wall 6. The handle opening 12 allows the handle section of the fishing rod to be inserted. Collectively, the support lip 11 and the handle opening 12 provide two separate securing points so that the fishing rod can be held within the present invention. The alignment slot 13 centrally traversing through the flat base 2 thus allowing the user to secure the present invention to a kayak and adjust a positioning angle of the support lip 11 via a coupling bolt.

In reference to FIG. 1-2, the arch body 1 further comprises a front edge 9 and a rear edge 10, wherein the front edge 9 and the rear edge 10 delineate the terminal edges of the arch body 1. The flat base 2 is extended from the front edge 9 to the rear edge 10. As a result, the flat base 2 is able to provide maximum contact surface area upon the kayak and prevent any lateral rocking motion when the present invention is mounted. The left arch wall 5 is extended from the front edge 9 to the rear edge 10. The right arch wall 6 is extended from the front edge 9 to the rear edge 10. The support lip 11 that seats the pole section of the fishing rod is connected into the front edge 9 and the flat base 2 thus outwardly extending from the flat base 2. The support lip 11 is shaped slightly larger than the pole section of the fishing rod to prevent any lateral movements. As a result, the pole section can extend beyond the arch body 1 and away from the kayak. The handle opening 12 is positioned adjacent to the rear edge 10 so that the handle section of the fishing rod can be inserted through the handle opening 12. For example, when a fish is hooked on the fishing rod, the downward force of the pole section is eliminated via the support lip 11, and the upward force of the handle section is eliminated via the handle opening 12.

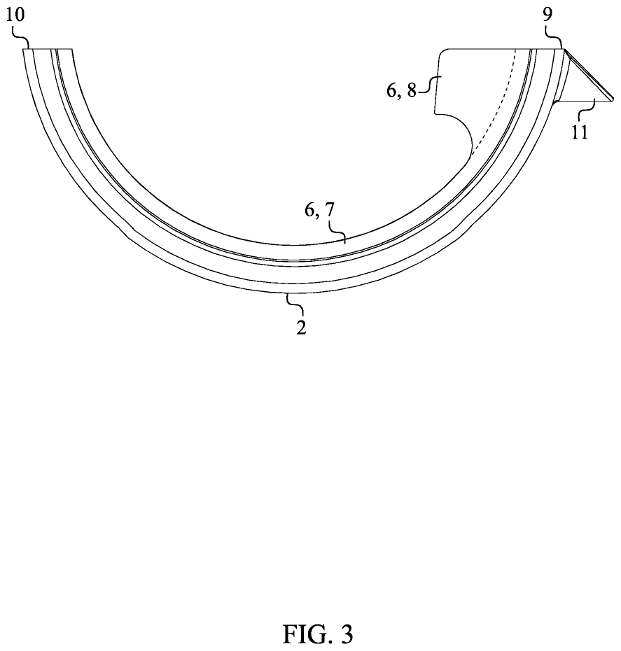

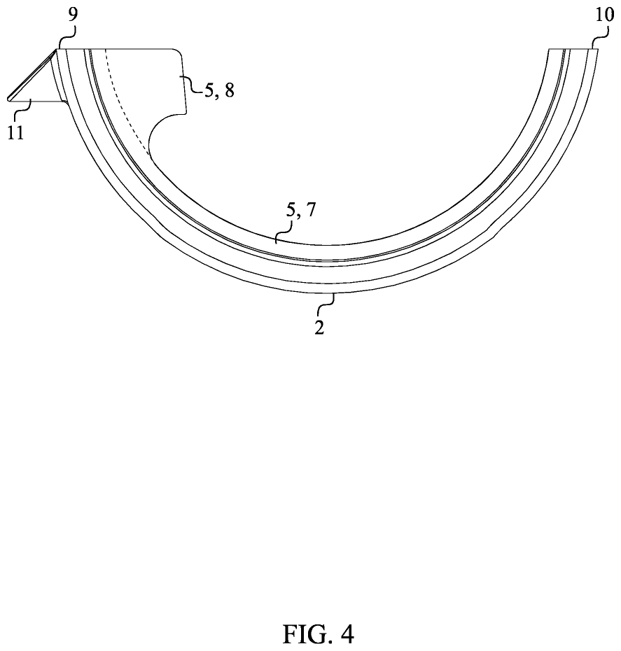

In reference to FIG. 3-4, the left arch wall 5 and the right arch wall 6 each comprises a flange section 7 and a reel locking section 8. More specifically, the flange section 7 is perimetrically connected around the flat base 2 from the front edge 9 to the rear edge 10 thus further strengthening the semicircular shape of the arch body 1. The reel locking section 8 is connected onto the flange section 7 and positioned adjacent to the support lip 11. The reel locking section 8 is oriented toward the rear end 4 and functions as a cantilever so that the reel can be locked. In other words, the reel body is placed below the reel locking section 8 and adjacent to the flange section 7 so that the reel can be locked within the arch body 1 to prevent any detachment of the fishing rod from the arch body 1. For example, when the reel is set up for left handed users, the reel body is placed outside of the left arch wall 5. When the reel is set up for right handed users, the reel body is placed outside of the right arch wall 6.

In reference to FIG. 1-2 and FIG. 5, the alignment slot 13 is linearly extended in between the support lip 11 and the handle opening 12 and centrally aligned within the left arch wall 5 and the right arch wall 6. More specifically, the user can insert the coupling bolt through the alignment slot 13 and mount the arch body 1 to the kayak or any other mounting surface. Once the coupling bolt is tightened, the flat base 2 is able to stably position atop the kayak or the mounting surface. Due to the fact that the alignment slot 13 extends in between the front end 3 to the rear end 4, the user can easily adjust the positioning angle of the present invention. More specifically, the position angle determines the angular positioning of the fishing rod within the present invention which can differ based on type of fishing methods, types of fishes, surrounding obstacles, and any other fishing related limitations or requirements. The position angle is defined in between the support lip 11 and a contact point of the flat base 2 that presses upon the kayak or any other mounting surface.

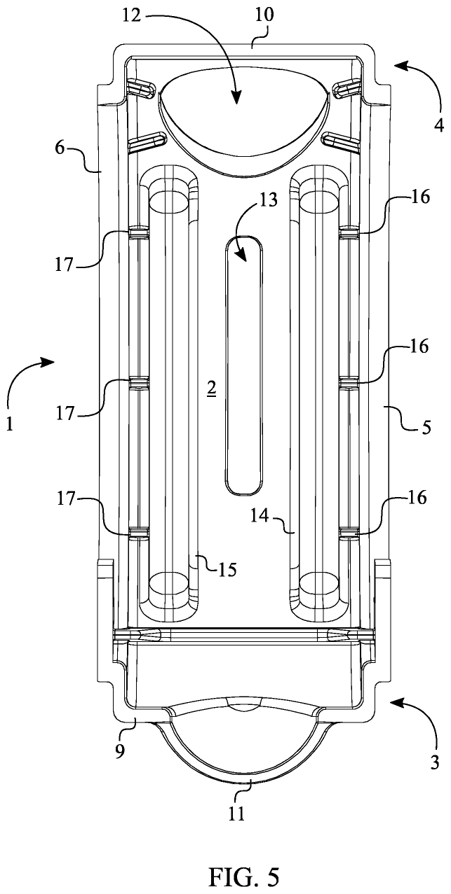

In reference to FIG. 5, the present invention further comprises a left structural rib 14 and a right structural rib 15 prevent flexing and twisting of the flat base 2. More specifically, the left structural rib 14 is connected along the flat base 2 and positioned in between the alignment slot 13 and the left arch wall 5. The right structural rib 15 is connected along the flat base 2 and positioned in between the alignment slot 13 and the right arch wall 6. The left structural rib 14 is linearly extended in between the support lip 11 and the handle opening 12, and the right structural rib 15 is linearly extended in between the support lip 11 and the handle opening 12. As a result, the left structural rib 14 and the right structural rib 15 are able to prevent flexing and twisting of the flat base 2 from the front edge 9 to the rear edge 10.

In reference to FIG. 5, the present invention further comprises a plurality of left structural supports 16 and a plurality of right structural supports 17. More specifically, the plurality of left structural supports 16 is connected to the left arch wall 5, the flat base 2, and the left structural rib 14 to prevent any twisting or flexing of the left arch wall 5. Each of the plurality of left structural supports 16 is evenly spaced along the left structural rib 14 so that the left arch wall 5 can be sufficiently and continuously strengthen along the left structural rib 14. The plurality of right structural supports 17 is connected to the right arch wall 6, the flat base 2, and the right structural rib 15 to prevent any twisting or flexing of the right arch wall 6. Each of the plurality of left structural supports 16 is evenly spaced along the right structural rib 15 so that the right arch wall 6 can be sufficiently and continuously strengthen along the right structural rib 15.

Due to the compact size, the user can easy paddle over the present invention as the existing fishing rod holders don't allow the user to comfortable paddle over. Due to the semicircular body of the present invention and the injection molded manufacturing process, the present invention floats on water and does not sink thus eliminating accidental lost. Furthermore, the present invention only utilizes a single moving connection between the alignment slot 13 and the coupling bolt to improve the reliability and the dependability.

Although the invention has been explained in relation to its preferred embodiment, it is to be understood that many other possible modifications and variations can be made without departing from the spirit and scope of the invention as hereinafter claimed.

What is claimed is:

1. A fishing rod holder comprising:
an arch body;
a support lip;
a handle opening;
an alignment slot;
the arch body comprising a flat base, a left arch wall, and a right arch wall;
the left arch wall and the right arch wall being oppositely positioned of each other about the flat base;
the left arch wall being perpendicularly connected to the flat base;
the right arch wall being perpendicularly connected to the flat base;
the support lip being connected to a front end of the flat base;
the support lip being centrally aligned within the left arch wall and the right arch wall;
the handle opening traversing through a rear end of the flat base;
the handle opening being centrally aligned within the left arch wall and the right arch wall; and
the alignment slot centrally traversing through the flat base.

2. The fishing rod holder as claimed in claim 1, wherein the arch body forms a semicircular body.

3. The fishing rod holder as claimed in claim 1 comprising:
the arch body further comprising a front edge and a rear edge;
the flat base being extended from the front edge to the rear edge;
the left arch wall being extended from the front edge to the rear edge;
the right arch wall being extended from the front edge to the rear edge;
the support lip being connected into the front edge and the flat base;
the support lip being outwardly extended from the flat base; and
the handle opening being positioned adjacent to the rear edge.

4. The fishing rod holder as claimed in claim 1 comprising:
the left arch wall and the right arch wall each comprising a flange section and a reel locking section;
the flange section being perimetrically connected around the flat base;
the reel locking section being connected onto the flange section;
the reel locking section being oriented toward the rear end; and
the reel locking section being positioned adjacent to the support lip.

5. The fishing rod holder as claimed in claim 1 comprising:
the alignment slot being linearly extended in between the support lip and the handle opening; and
the alignment slot being centrally aligned within the left arch wall and the right arch wall.

6. The fishing rod holder as claimed in claim 1 comprising:
a left structural rib;
a right structural rib;
the left structural rib being connected along the flat base;
the left structural rib being positioned in between the alignment slot and the left arch wall;
the left structural rib being linearly extended in between the support lip and the handle opening;
the right structural rib being connected along the flat base;
the right structural rib being positioned in between the alignment slot and the right arch wall; and
the right structural rib being linearly extended in between the support lip and the handle opening.

7. The fishing rod holder as claimed in claim 6 comprising:
a plurality of left structural supports;
a plurality of right structural supports;
the plurality of left structural supports being connected to the left arch wall, the flat base, and the left structural rib;
each of the plurality of left structural supports being evenly spaced along the left structural rib;
the plurality of right structural supports being connected to the right arch wall, the flat base, and the right structural rib; and
each of the plurality of right structural supports being evenly spaced along the right structural rib.

8. A fishing rod holder comprising:
an arch body;
a support lip;
a handle opening;
an alignment slot;
a left structural rib;
a right structural rib;
the arch body comprising a flat base, a left arch wall, and a right arch wall;
the left arch wall and the right arch wall being oppositely positioned of each other about the flat base;
the left arch wall being perpendicularly connected to the flat base;
the right arch wall being perpendicularly connected to the flat base;
the support lip being connected to a front end of the flat base;
the support lip being centrally aligned within the left arch wall and the right arch wall;
the handle opening traversing through a rear end of the flat base;
the handle opening being centrally aligned within the left arch wall and the right arch wall;
the alignment slot centrally traversing through the flat base;
the left structural rib being connected along the flat base; and
the right structural rib being connected along the flat base.

9. The fishing rod holder as claimed in claim 8, wherein the arch body forms a semicircular body.

10. The fishing rod holder as claimed in claim 8 comprising:
the arch body further comprising a front edge and a rear edge;
the flat base being extended from the front edge to the rear edge;
the left arch wall being extended from the front edge to the rear edge;
the right arch wall being extended from the front edge to the rear edge;
the support lip being connected into the front edge and the flat base;
the support lip being outwardly extended from the flat base; and
the handle opening being positioned adjacent to the rear edge.

11. The fishing rod holder as claimed in claim 8 comprising:
the left arch wall and the right arch wall each comprising a flange section and a reel locking section;
the flange section being perimetrically connected around the flat base;
the reel locking section being connected onto the flange section;
the reel locking section being oriented toward the rear end; and
the reel locking section being positioned adjacent to the support lip.

12. The fishing rod holder as claimed in claim 8 comprising:
the alignment slot being linearly extended in between the support lip and the handle opening; and
the alignment slot being centrally aligned within the left arch wall and the right arch wall.

13. The fishing rod holder as claimed in claim 8 comprising:
the left structural rib being positioned in between the alignment slot and the left arch wall;
the left structural rib being linearly extended in between the support lip and the handle opening;
the right structural rib being positioned in between the alignment slot and the right arch wall; and
the right structural rib being linearly extended in between the support lip and the handle opening.

14. The fishing rod holder as claimed in claim 13 comprising:
a plurality of left structural supports;
a plurality of right structural supports;
the plurality of left structural supports being connected to the left arch wall, the flat base, and the left structural rib;
each of the plurality of left structural supports being evenly spaced along the left structural rib;
the plurality of right structural supports being connected to the right arch wall, the flat base, and the right structural rib; and
each of the plurality of right structural supports being evenly spaced along the right structural rib.

15. A fishing rod holder comprising:
an arch body;
a support lip;
a handle opening;
an alignment slot;
a left structural rib;
a right structural rib;
a plurality of left structural supports;
a plurality of right structural supports;
the arch body comprising a flat base, a left arch wall, and a right arch wall;
the left arch wall and the right arch wall being oppositely positioned of each other about the flat base;
the left arch wall being perpendicularly connected to the flat base;
the right arch wall being perpendicularly connected to the flat base;
the support lip being connected to a front end of the flat base;
the support lip being centrally aligned within the left arch wall and the right arch wall;
the handle opening traversing through a rear end of the flat base;
the handle opening being centrally aligned within the left arch wall and the right arch wall;
the alignment slot centrally traversing through the flat base;
the left structural rib being connected along the flat base;
the right structural rib being connected along the flat base;
the plurality of left structural supports being connected to the left arch wall, the flat base, and the left structural rib; and
the plurality of right structural supports being connected to the right arch wall, the flat base, and the right structural rib.

16. The fishing rod holder as claimed in claim 15, wherein the arch body forms a semicircular body.

17. The fishing rod holder as claimed in claim 15 comprising:
the arch body further comprising a front edge and a rear edge;
the flat base being extended from the front edge to the rear edge;
the left arch wall being extended from the front edge to the rear edge;
the right arch wall being extended from the front edge to the rear edge;
the support lip being connected into the front edge and the flat base;
the support lip being outwardly extended from the flat base; and
the handle opening being positioned adjacent to the rear edge.

18. The fishing rod holder as claimed in claim 15 comprising:
the left arch wall and the right arch wall each comprising a flange section and a reel locking section;
the flange section being perimetrically connected around the flat base;
the reel locking section being connected onto the flange section;
the reel locking section being oriented toward the rear end; and
the reel locking section being positioned adjacent to the support lip.

19. The fishing rod holder as claimed in claim 15 comprising:
the alignment slot being linearly extended in between the support lip and the handle opening; and
the alignment slot being centrally aligned within the left arch wall and the right arch wall.

20. The fishing rod holder as claimed in claim 15 comprising:
the left structural rib being positioned in between the alignment slot and the left arch wall;
the left structural rib being linearly extended in between the support lip and the handle opening;
the right structural rib being positioned in between the alignment slot and the right arch wall;
the right structural rib being linearly extended in between the support lip and the handle opening;
each of the plurality of left structural supports being evenly spaced along the left structural rib; and
each of the plurality of right structural supports being evenly spaced along the right structural rib.
